(19) United States
(12) Patent Application Publication
(10) Pub. No.: US 2026/0127466 A1
(43) Pub. Date: May 7, 2026

(54) OPTIMIZING CLASSICAL RESOURCES DURING TRANSPILATION OF DYNAMIC QUANTUM CIRCUITS

(71) Applicant: International Business Machines Corporation, Armonk, NY (US)

(72) Inventors: Derek Wang, New York, NY (US); Pedro Rivero Ramirez, Long Island City, NY (US); Iskandar Sitdikov, New York, NY (US); Alireza Seif Tabrizi, Adelphi, MD (US); Haimeng Zhang, New York, NY (US)

(21) Appl. No.: 18/918,567

(22) Filed: Oct. 17, 2024

(51) Int. Cl. G06N 10/20

(52) U.S. Cl. CPC G06N 10/20

(57) ABSTRACT

A method, system, and computer program product for improving transpilation of dynamic quantum circuits. Classical resources utilized by the dynamic quantum circuit are optimized during transpilation of the dynamic quantum circuit so as to reduce the classical resource requirements. Such optimization of the classical resources is based on optimizing the classical memory requirements, optimizing the classical processing time, and/or optimizing the classical information flow. Upon optimizing, during transpilation, the classical resources utilized by the dynamic quantum circuit, a set of classical instructions is generated based on the optimization of the classical resources. Such classical instructions are then compiled during the transpilation of the dynamic quantum circuit. As a result, there is an improved performance of the transpiled dynamic quantum circuit, including an improvement in the quantum computational performance.

### TECHNICAL FIELD

The present disclosure relates generally to transpilation of dynamic quantum circuits, and more particularly to optimizing classical resources during transpilation of dynamic quantum circuits so as to improve the quantum computational performance.

### BACKGROUND

Dynamic quantum circuits are quantum circuits with mid-circuit measurements and feed-forward classical operations which allow such circuits to be adaptive on-the-fly. A mid-circuit measurement is a quantum measurement at an intermediate point in the quantum circuit as opposed to a measurement at the end point of the quantum circuit thereby allowing dynamic adaptations based on the results. Feed-forward classical operations (or simply referred to herein as “feed-forward operations”) refer to the real-time adaptation of the quantum circuits based on earlier measurement outcomes.

### SUMMARY

In one embodiment of the present disclosure, a method for improving transpilation of dynamic quantum circuits comprises optimizing, during transpilation of a dynamic quantum circuit, classical resources utilized by the dynamic quantum circuit to reduce classical resource requirements. The method further comprises generating a set of classical instructions based on the optimization of the classical resources utilized by the dynamic quantum circuit. The method additionally comprises compiling the set of classical instructions during the transpilation of the dynamic quantum circuit.

Other forms of the embodiment of the method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for improving the transpilation of the dynamic quantum circuits so as to improve the quantum computational performance in accordance with an embodiment of the present disclosure;

FIGS. 3A-3B illustrate re-using a classical register for a repeat-until-success loop in accordance with an embodiment of the present disclosure;

FIGS. 4A-4C illustrate optimizing classical logic to minimize the feed-forward time in accordance with an embodiment of the present disclosure;

FIGS. 5A-5B illustrate limiting a classical processor to not store greater than a maximum number of bits per time step or group of qubits in order to prevent crashing of the classical processor in accordance with an embodiment of the present disclosure;

FIG. 6 illustrates an embodiment of the present disclosure of the hardware configuration of the classical computer which is representative of a hardware environment for practicing the present disclosure; and

FIG. 7 is a flowchart of a method for improving transpilation of dynamic quantum circuits in accordance with an embodiment of the present disclosure.

### DETAILED DESCRIPTION

As stated above, dynamic quantum circuits are quantum circuits with mid-circuit measurements and feed-forward classical operations which allow such circuits to be adaptive on-the-fly. A mid-circuit measurement is a quantum measurement at an intermediate point in the quantum circuit as opposed to a measurement at the end point of the quantum circuit thereby allowing dynamic adaptations based on the results. Feed-forward classical operations (or simply referred to herein as “feed-forward operations”) refer to the real-time adaptation of the quantum circuits based on earlier measurement outcomes.

Dynamic quantum circuits are a fundamental part of utility-scale quantum computation (quantum utility is when a quantum computer is able to reliably solve problems at a scale that is beyond the capabilities of traditional classical computers using brute force methods), ranging from generating long-range entanglement more efficiently to executing core algorithmic primitives (e.g., quantum Fourier transform) to the foundation of active quantum error correction.

Transpilation of quantum circuits, including dynamic quantum circuits, is a fundamental step in quantum computation. Transpilation, which is performed by a component referred to as a transpiler, is the process of rewriting a given input quantum circuit to match the topology of a specific quantum device, and optimize the circuit instructions for execution on noisy quantum computers. It optimizes the quantum circuit by decomposing complex gates, rearranging qubits to match hardware connectivity, minimizing gate count, and managing available resources. The process ensures the quantum circuit retains functionality while maximizing performance and compatibility with the target hardware platform. Hence, it is a necessary step in order to execute the program on a quantum computer. However, it can alter the quantum circuit's characteristics, such as the width, the depth, and the gates.

The stages of transpilation may include the following six stages. The first stage (init) is the initial stage, which runs initial passes that are required before the quantum circuit can be embedded. Such a stage typically involves unrolling custom instructions and converting the quantum circuit to all single and two-qubit gates. The second stage (layout) performs the mapping of the virtual qubits in the quantum circuit to the quantum processing unit's physical qubits. The third stage (routing) injects gates in the original quantum circuit to make it compatible with the quantum processing unit's connectivity. The fourth stage (translation) translates the gates in the quantum circuit to the quantum processing unit's basis set of instructions. In the fifth stage (optimization), an optimization loop is run to find more efficient decompositions of the quantum circuit until a condition is met (e.g., a particular depth of the quantum circuit, which represents the number of time steps required to complete all the gates in the quantum circuit). The sixth stage (scheduling) is used for any hardware-aware scheduling passes. For example, if the user specifies a scheduling method, the sixth stage accounts for all the idle time in the quantum circuit.

The performance of dynamic quantum circuits depends on both the quantum processing unit of the quantum computer and the central processing unit of the classical computer upon which such quantum circuits are executed. For example, the performance of the dynamic quantum circuit depends on the limited coherence time and the qubit count involving the quantum processing unit. In another example, the performance of the dynamic quantum circuit depends on the information transmission rate, memory, and processing rate involving the central processing unit of the classical computer.

However, the transpilation process of the dynamic quantum circuit does not take into consideration the classical portion involving the classical resources utilized by the dynamic quantum circuit upon which its performance depends. As a result, the current transpilation process of the dynamic quantum circuit may result in inadequate performance of the transpiled dynamic quantum circuit, including deficient quantum computational performance.

The embodiments of the present disclosure provide the means for optimizing, during transpilation of the dynamic quantum circuit, the classical resources utilized by the dynamic quantum circuit to reduce classical resource requirements thereby improving performance of the transpiled dynamic quantum circuit. In one embodiment, such optimization of the classical resources utilized by the dynamic quantum circuit to reduce classical resource requirements is based on optimizing the classical memory requirements, optimizing the classical processing time, and/or optimizing the classical information flow. For example, optimizing the classical memory requirements may involve using the knowledge of the memory limit of classical controllers to reduce the number of classical registers required to execute the classical logic. In another example, optimizing the classical processing time may involve minimizing feed-forward times. In a further example, optimizing the classical information flow may involve limiting a classical processor to not store greater than a maximum number of bits per time step or group of qubits in order to prevent crashing by the classical processor. Upon optimizing, during transpilation, the classical resources utilized by the dynamic quantum circuit, a set of classical instructions is generated based on the optimization of the classical resources. Such classical instructions are then compiled during the transpilation of the dynamic quantum circuit. As previously discussed, the performance of the dynamic quantum circuit depends on the utilization of the classical resources. As a result of optimizing, during the transpilation of the dynamic quantum circuit, the classical resources utilized by the dynamic quantum circuit to reduce classical resource requirements, there is an improved performance of the transpiled dynamic quantum circuit, including an improvement in the quantum computational performance. These and other features will be discussed in further detail below.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

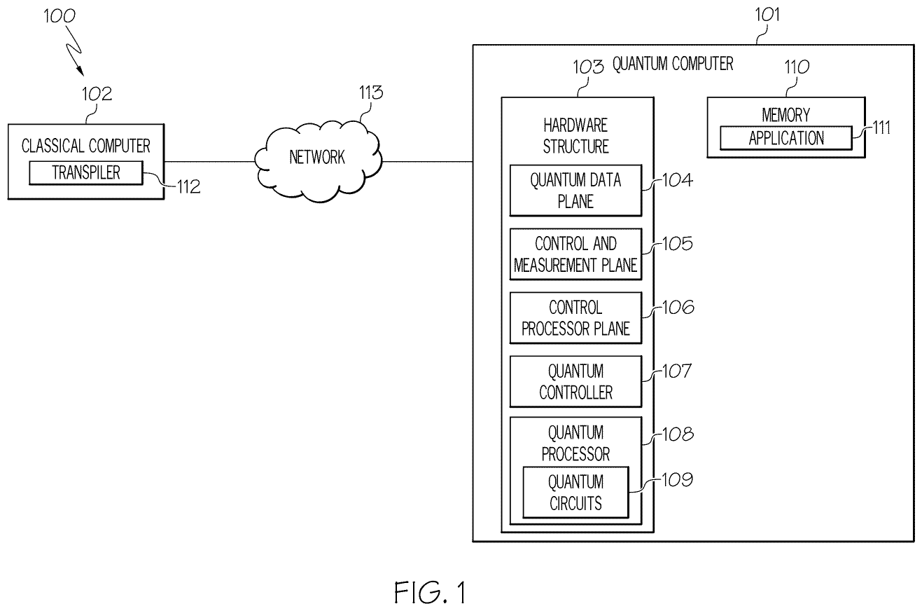

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to improve the transpilation of the dynamic quantum circuits so as to improve the quantum computational performance.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits'state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθX/2}, which corresponds to a rotation of the qubit state around the X-axis by the given angle theta θ on the Bloch sphere), RY (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

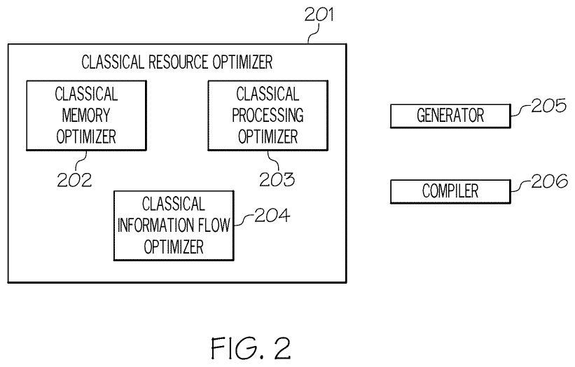

In one embodiment, memory 110 stores an application 111 that may be configured to implement one or more of the methods described herein in accordance with one or more embodiments. For example, application 111 may implement a program for improving the transpilation of the dynamic quantum circuits so as to improve the quantum computational performance as discussed further below in connection with FIGS. 2, 3A-3B, 4A-4C, 5A-5B and 7. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit. transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits. In one embodiment, transpiler 112 corresponds to the “context-aware” transpiler of the present disclosure configured to improve the transpilation of the dynamic quantum circuit so as to improve the quantum computational performance as discussed below in connection with FIGS. 2, 3A-3B, 4A-4C, 5A-5B and 7.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features) * (number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

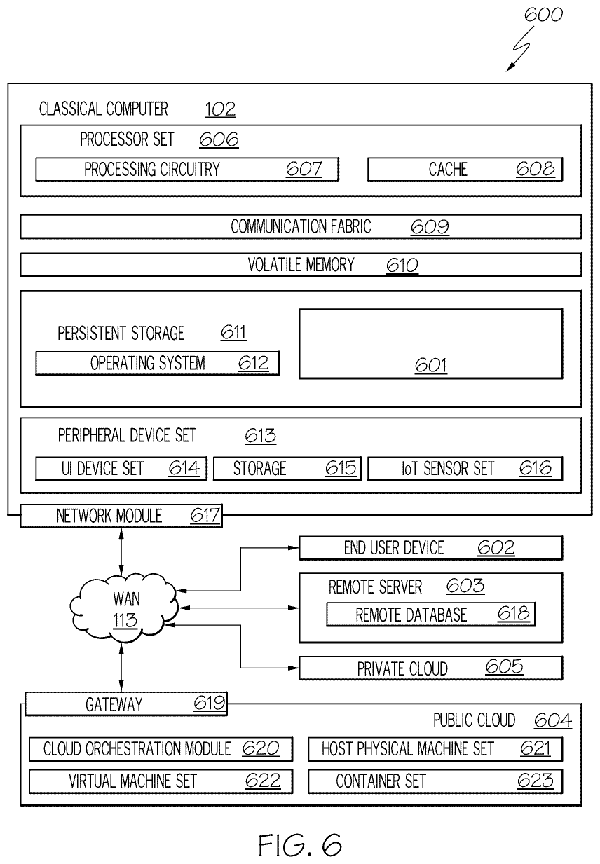

Furthermore, classical computer 102 is configured to improve the transpilation of the dynamic quantum circuits so as to improve the quantum computational performance as discussed further below in connection with FIGS. 2, 3A-3B, 4A-4C, 5A-5B and 7. A description of the software components of classical computer 102 is provided below in connection with FIG. 2 and a description of the hardware configuration of classical computer 102 is provided further below in connection with FIG. 6.

System 100 is not to be limited in scope to any one particular network architecture. System 100 may include any number of quantum computers 101, classical computers 102, and networks 113.

A discussion regarding the software components used by classical computer 102 for improving the transpilation of the dynamic quantum circuits so as to improve the quantum computational performance is provided below in connection with FIG. 2.

FIG. 2 is a diagram of the software components of classical computer 102 (FIG. 1) for improving the transpilation of the dynamic quantum circuits so as to improve the quantum computational performance in accordance with an embodiment of the present disclosure.

It is noted that the components discussed herein in connection with FIG. 2 may reside within transpiler 112, which may function as a context-aware transpiler.

Referring to FIG. 2, in conjunction with FIG. 1, classical computer 102 includes classical resource optimizer 201 configured to optimize, during transpilation of the dynamic quantum circuit, the classical resources utilized by the dynamic quantum circuit in order to reduce the classical resource requirements.

Classical resources, as used herein, refer to the resources utilized by the dynamic quantum circuit, upon which its performance depends, that relate to classical operations, such as operations performed by the central processing unit of classical computer 102.

In one embodiment, classical resource optimizer 201 optimizes the classical resources utilized by the dynamic quantum circuit using classical memory optimizer 202 to optimize (e.g., minimize) the classical memory requirements, classical processing optimizer 203 to optimize (e.g., minimize) the classical processing time, and classical information flow optimizer 204 to optimize the classical information flow.

In one embodiment, classical memory optimizer 202 is configured to manage classical memory to efficiently use on-chip classical resources.

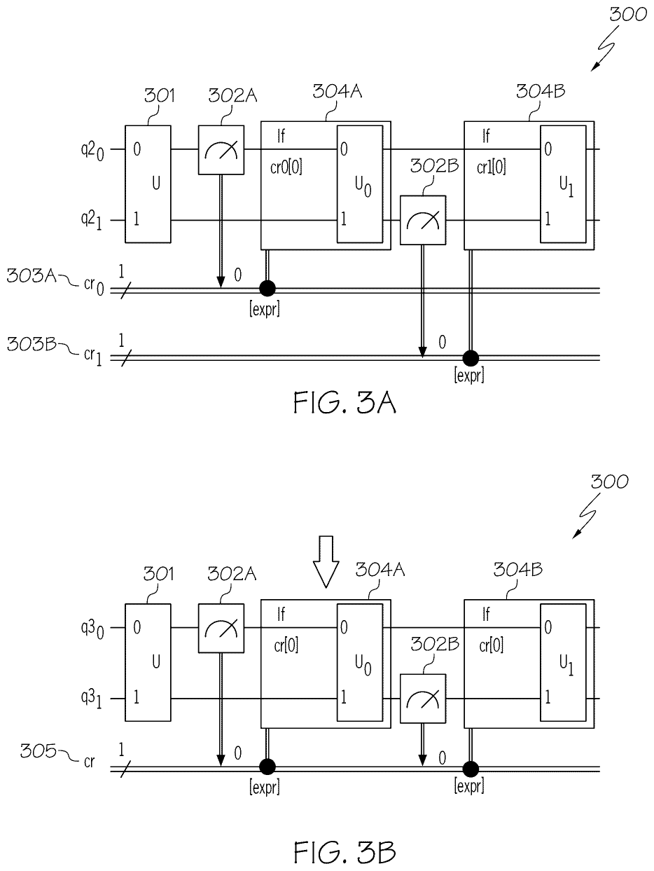

In one embodiment, classical memory optimizer 202 optimizes the classical memory requirements by re-using a classical register for a repeat-until-success loop as shown in FIGS. 3A-3B.

FIGS. 3A-3B illustrate re-using a classical register for a repeat-until-success loop in accordance with an embodiment of the present disclosure.

A repeat-until-success loop, as used herein, refers to the dynamic quantum circuit (e.g., quantum circuit 109) using mid-circuit measurements to produce a circuit that repeats until a successful syndrome measurement.

As shown in FIG. 3A, a unitary operation (U) 301 is applied to qubits q2₀ and q2₁ followed by applying mid-circuit measurement 302A to qubit q2₀ performed by dynamic quantum circuit 300. After the mid-circuit measurement of unitary operation (U) 301 is applied to qubit q2 the result is stored in classical register 303A (cr0). Dynamic quantum circuit 300 applies U₀ 304A if the measurement reports 0, which is exported to the expression (expr) namespace on classical register 303A (cr0). Such an operation is repeated with respect to applying mid-circuit measurement 302B to qubit q2₁ involving classical register 303B (cr1).

For example, FIG. 3A illustrates applying mid-circuit measurement 302B to qubit q2₁ performed by dynamic quantum circuit 300. After the mid-circuit measurement of unitary operation (U) 301 is applied to qubit q2₁, the result is stored in classical register 303B (cr1). Dynamic quantum circuit 300 applies U₁ 304B if the measurement reports 0, which is exported to the expression (expr) namespace on classical register 303B (cr1).

Since dynamic quantum circuit 300 performs a repeat-until-success operation, a classical register may be re-used thereby minimizing classical memory requirements.

For example, as shown in FIG. 3B, the results of applying the mid-circuit measurements, mid-circuit measurements 302A, 302B, of unitary operation (U) 301 to qubits q3₀ and q3₁, respectively, are now stored in a single classical register 305 (cr). Dynamic quantum circuit 300 applies U₀ 304A if the measurement (applying mid-circuit measurement 302A to qubit q3₀) reports 0, which is exported to the expression (expr) namespace on classical register 305 (cr), and applies U₁ 304B if the measurement (applying mid-circuit measurement 302B to qubit q3₁) reports 0, which is exported to the expression (expr) namespace on classical register 305 (cr).

Returning to FIG. 2, another example of optimizing (e.g., minimizing) the classical memory requirements includes minimizing classical bit requirements over segments of the dynamic quantum circuit since different classical processors may be attached to different qubits.

Another example of optimizing (e.g., minimizing) the classical memory requirements includes merging classical bits in response to identifying symmetries in classical logic conditions.

A further example of optimizing (e.g., minimizing) the classical memory requirements includes re-using the classical register based on the scheduling of parallel operations in the dynamic quantum circuit.

Another example of optimizing (e.g., minimizing) the classical memory requirements involves using the knowledge of the memory limit of classical controllers to reduce the number of classical registers required to execute the classical logic.

In one embodiment, classical memory optimizer 202 optimizes (e.g., minimizes) the classical memory requirements in the manner discussed above using various software tools, which may include, but are not limited to, Qiskit®, Cirq®, Quipper, Quantinuum®, etc.

In one embodiment, classical processing optimizer 203 is configured to optimize (e.g., minimize) the classical processing time.

In one embodiment, classical processing optimizer 203 optimizes (e.g., minimizes) the classical processing time by minimizing feed-forward times, and thus, decreasing decoherence. Feed-forward, as used herein, refers to using selective measurements during the execution of a quantum circuit (e.g., dynamic quantum circuit) and adapts future operations depending on those measurement results. Feed-forward time, as used herein, refers to the duration of time that a feed-forward operation occurs. Decoherence, as used herein, refers to the process by which information of a quantum system is altered by the system's interaction with its environment, hence creating an entanglement between the quantum system and the environment.

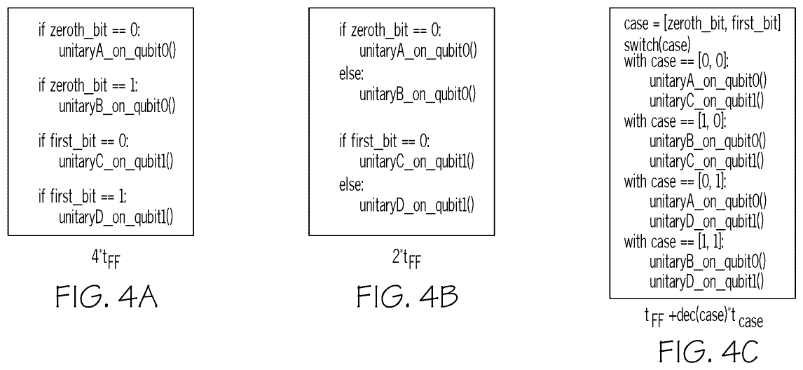

In one embodiment, feed-forward times are minimized by optimizing the classical logic as illustrated in FIGS. 4A-4C.

FIGS. 4A-4C illustrate optimizing classical logic to minimize the feed-forward time in accordance with an embodiment of the present disclosure.

As shown in FIGS. 4A-4C, there may be several different classical expressions for performing the same function, such as performing unitary operations (unitaryA, unitaryB, unitaryC, and unitaryD) on qubits 0 and 1.

For example, FIG. 4A illustrates a classical expression using a series of if statements (four if statements) to represent classical logic for performing unitary operations (unitaryA, unitaryB, unitaryC, and unitaryD) on qubits 0 and 1.

In one embodiment, classical processing optimizer 203 performs an analysis for the classical expression, such as shown in FIG. 4A, as to the total feed-forward time for performing the classical expression. As illustrated in FIG. 4A, the total feed-forward time for performing the classical expression of FIG. 4A is 4*t_{FF}, where t_{FF} corresponds to the time for the feed-forward operation of a single classical expression.

FIG. 4B illustrates a classical expression using a series of if-else statements (two sets of if-else statements) to perform the same classical logic as shown in FIG. 4A, i.e., classical logic for performing unitary operations (unitaryA, unitaryB, unitaryC, and unitaryD) on qubits 0 and 1.

As previously discussed, classical processing optimizer 203 performs an analysis for the classical expression, such as shown in FIG. 4B, as to the total feed-forward time for performing the classical expression. As illustrated in FIG. 4B, the total feed-forward time for performing the classical expression of FIG. 4B is 2*t_{FF}, which is smaller than the feed-forward time for performing the classical expression of FIG. 4A.

FIG. 4C illustrates a classical expression using a switch statement to perform the same classical logic as shown in FIGS. 4A and 4B, i.e., classical logic for performing unitary operations (unitaryA, unitaryB, unitaryC, and unitaryD) on qubits 0 and 1.

As discussed above, classical processing optimizer 203 performs an analysis for the classical expression, such as shown in FIG. 4C, as to the total feed-forward time for performing the classical expression. As illustrated in FIG. 4C, the total feed-forward time for performing the classical expression of FIG. 4C is t_{FF}+dec(case)*t_{case} which is smaller than the feed-forward time for performing the classical expressions of FIGS. 4A and 4B, where t_{case} is the time to evaluate a single case in a switch statement, and where dec( ) converts a binary into decimal form (e.g., dec(00)=0, dec(01)=1, dec(10)=2, dec(11)=3).

After considering the different feed-forward times for each classical expression, the classical logic with the minimal feed-forward time is then selected to be utilized. In this manner, classical logic is optimized to minimize the feed-forward time, and thus, decrease decoherence.

In one embodiment, classical processing optimizer 203 performs an analysis for the classical expressions, such as shown in FIGS. 4A-4C, as to the total feed-forward time for performing the classical expression using various software tools, which may include, but are not limited to, Qiskit®, Cirq®, Quipper, Quantinuum®, etc.

Another example of classical processing optimizer 203 optimizing (e.g., minimizing) the classical processing time includes approximating compilation, where low-probability classical cases are discarded to minimize the compilation overhead.

A further example of classical processing optimizer 203 optimizing (e.g., minimizing) the classical processing time includes optimizing quantum gates across classical logic conditions. For example, if before the classical condition a unitary operation (U) is applied, and for the other cases, the unitary operation (U) and identity operation (I) are applied, then the quantum gate count can be minimized by not applying any gates before the classical condition and applying the unitary operation (U) for fewer conditions.

Another example of classical processing optimizer 203 optimizing (e.g., minimizing) the classical processing time includes replacing the classical logic with an efficient quantum circuit. For example, the parity measurement is projected out to an ancilla qubit. A parity measurement is a procedure in quantum information science used for error detection in quantum qubits. A parity measurement checks the equality of two qubits to return a true or false answer, which can be used to determine whether a correction needs to occur. Such a measurement may be stored in an ancilla qubit. Ancilla qubits, as used herein, refer to the extra qubits used to implement irreversible logical operations. For example, when translating a classical circuit into a quantum circuit, extra qubits are introduced because quantum computers only implement reversible logic. Such extra qubits are referred to as “ancilla” (or ancillary) qubits.

A further example of classical processing optimizer 203 optimizing (e.g., minimizing) the classical processing time includes iterating with the management of classical memory. For example, a single bit is stored in response to unitaries being determined by a symmetry of a wave function.

In one embodiment, classical processing optimizer 203 optimizes (e.g., minimizes) the classical processing time in the various manners discussed above using various software tools, which may include, but are not limited to, Qiskit®, Cirq®, Quipper, Quantinuum®, etc.

In one embodiment, classical information flow optimizer 204 is configured to optimize the classical information flow.

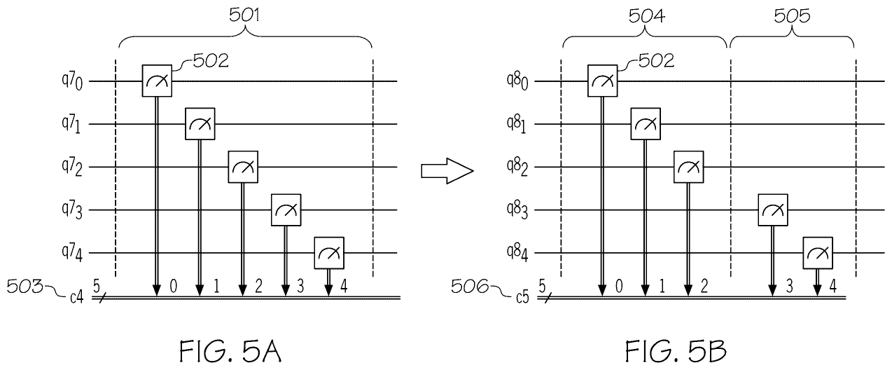

For example, classical information flow optimizer 204 optimizes the classical information flow by controlling the information flow to prevent the classical processors from crashing as shown in FIGS. 5A-5B.

FIGS. 5A-5B illustrate limiting a classical processor to not store greater than a maximum number of bits per time step or group of qubits in order to prevent crashing of the classical processor in accordance with an embodiment of the present disclosure.

As shown in FIG. 5A, a classical processors is requested to store five bits per time step 501 or group of qubits (q7₀, q7₁, q7₂, q7₃, and q7ᵣ). For example, measurement operations 502 are performed for various qubits (q7₀, q7₁, q7₂, q7₃, and q7r), where such measurement operations 502 output five bits of classical information to classical processor 503 (c4) per time step 501.

If such a classical processor can only store at most 3 bits per time step or group of qubits before failing, then the information flow needs to be adjusted in such a manner that the classical processor only stores 3 bits per time step as shown in FIG. 5B.

FIG. 5B illustrates that time step 501 of FIG. 5A is divided into two separate time steps, such as time steps 504 and 505. Such time steps, such as time steps 504 and 505, ensure that the classical processor does not store more than 3 bits per time step or group of qubits. For example, measurement operations 502 are performed for qubits q8₀, q8₁, and q8₂ over time step 504 and measurement operations 502 are performed for qubits q8₃, and q8₄ over time step 505. Measurement operations 502 for qubits q8₀, q8₁, and q8₂ output three bits of classical information to classical processor 506 (c5) over time step 504 and measurement operations 502 for qubits q8₃, and q8₄ output two bits of classical information over time step 505 to classical processor 506 (c5). In this manner, by controlling the information flow, the crashing of classical processors is prevented.

Another example of classical information flow optimizer 204 optimizing the classical information flow includes adjusting the classical information flow based on the limitations of each of the classical processors attached to the different qubits. For example, different qubits may be attached to different classical processors, each with their own information flow limitations, such as classical bit register sizes, flow rate, or complexity of logical processing. By taking into consideration such limitations, the classical information flow may be optimized, such as by adjusting the classical bit register sizes, flow rate, or complexity of logical processing.

A further example of classical information flow optimizer 204 optimizing the classical information flow includes iterating with the optimization of classical logic with cumulative cost functions. For instance, classical logic conditions that need be performed in sequence versus parallel are identified in order to optimize the classical logic with cumulative cost functions.

Another example of classical information flow optimizer 204 optimizing the classical information flow includes iterating with subsequent steps of the standard transpilation stages (e.g., translation, optimization, scheduling). For instance, the quantum gates that can be performed in parallel with classical logic are identified, which can be used to optimize the classical information flow.

In one embodiment, classical information flow optimizer 204 optimizes the classical information flow in the various manners discussed above using various software tools, which may include, but are not limited to, Qiskit®, Cirq®, Quipper, Quantinuum®, etc.

As a result of such optimization to the classical resources, the classical resource requirements are reduced.

Classical computer 102 further includes generator 205 configured to generate a set of classical instructions based on the optimization of the classical resources utilized by the dynamic quantum circuit that reduces the classical resource requirements. For example, generator 205 may generate a set of classical instructions to re-use a classical register as discussed above in connection with FIGS. 3A-3B. In another example, generator 205 may generate a set of classical instructions to utilize the classical logic shown in FIG. 4C, which minimizes the feed-forward time, and thus decreases decoherence. In a further example, generator 205 may generate a set of classical instructions to limit the classical processor from not storing greater than a maximum number of bits per time step or group of qubits in order to prevent crashing of the classical processor as discussed above in connection with FIGS. 5A-5B.

In one embodiment, generator 205 generates such a set of classical instructions using OpenQASM. In one embodiment, such classical instructions may include both low-level and high-level instructions. Such low-level instructions include classical bits and registers, comparison (Boolean) instructions, integers, angles, floating-point numbers, complex numbers, evaluation orders, looping and branching (e.g., if-else statements, for loops, while loops, etc.), switch statements, etc. Higher-level instructions include external function calls, which execute complex blocks of classical code.

In another embodiment, generator 205 generates such a set of classical instructions using the Instruction class of Qiskit®.

Furthermore, classical computer 102 includes compiler 206 configured to compile the set of classical instructions during the transpilation of the dynamic quantum circuit. In one embodiment, compiling classical instructions involves a process that translates classical code into a quantum algorithm that can be executed on quantum computer 101. For example, compiler 206 may break down the classical code into its basic building blocks and replace control and data structures with quantum primitives.

In one embodiment, the set of instructions are compiled between an optimization step and a scheduling step during the transpilation of the dynamic quantum circuit (e.g., quantum circuit 109).

In one embodiment, compiler 206 performs such compilation using the classical function compiler of Qiskit®. In one embodiment, the classical function compiler of Qiskit® maps the classical functions into a quantum circuit. In one embodiment, the classical function compiler of Qiskit® uses the Tweedledum library to represent the logic networks and to synthesize them into quantum circuits.

In this manner, by optimizing, during the transpilation of the dynamic quantum circuit, the classical resources utilized by the dynamic quantum circuit, there is an improved performance of the transpiled dynamic quantum circuit, including an improvement in the quantum computational performance.

A further description of these and other functions is provided below in connection with the discussion of the method for improving transpilation of dynamic quantum circuits.

Prior to the discussion of the method for improving transpilation of dynamic quantum circuits, a description of the hardware configuration of classical computer 102 (FIG. 1) is provided below in connection with FIG. 6.

Referring now to FIG. 6, in conjunction with FIG. 1, FIG. 6 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code 601 involved in performing the inventive methods, such as improving transpilation of dynamic quantum circuits. In addition to block 601, computing environment 600 includes, for example, classical computer 102, network 113, such as a wide area network (WAN), end user device (EUD) 602, remote server 603, public cloud 604, and private cloud 605. In this embodiment, classical computer 102 includes processor set 606 (including processing circuitry 607 and cache 608), communication fabric 609, volatile memory 610, persistent storage 611 (including operating system 612 and block 601, as identified above), peripheral device set 613 (including user interface (UI) device set 614, storage 615, and Internet of Things (IoT) sensor set 616), and network module 617. Remote server 603 includes remote database 618. Public cloud 604 includes gateway 619, cloud orchestration module 620, host physical machine set 621, virtual machine set 622, and container set 623.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 618. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically classical computer 102, to keep the presentation as simple as possible. Classical computer 102 may be located in a cloud, even though it is not shown in a cloud in FIG. 6. On the other hand, classical computer 102 is not required to be in a cloud except to any extent as may be affirmatively indicated.

Processor set 606 includes one, or more, computer processors of any type now known or to be developed in the future. Processing circuitry 607 may be distributed over multiple packages, for example, multiple, coordinated integrated circuit chips. Processing circuitry 607 may implement multiple processor threads and/or multiple processor cores. Cache 608 is memory that is located in the processor chip package(s) and is typically used for data or code that should be available for rapid access by the threads or cores running on processor set 606. Cache memories are typically organized into multiple levels depending upon relative proximity to the processing circuitry. Alternatively, some, or all, of the cache for the processor set may be located “off chip.” In some computing environments, processor set 606 may be designed for working with qubits and performing quantum computing.

Computer readable program instructions are typically loaded onto classical computer 102 to cause a series of operational steps to be performed by processor set 606 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 608 and the other storage media discussed below. The program instructions, and associated data, are accessed by processor set 606 to control and direct performance of the inventive methods. In computing environment 600, at least some of the instructions for performing the inventive methods may be stored in block 601 in persistent storage 611.

Communication fabric 609 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 610 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 610 is located in a single package and is internal to classical computer 102, but, alternatively or additionally, the volatile memory may be distributed over multiple packages and/or located externally with respect to classical computer 102.

Persistent Storage 611 is any form of non-volatile storage for computers that is now known or to be developed in the future. The non-volatility of this storage means that the stored data is maintained regardless of whether power is being supplied to classical computer 102 and/or directly to persistent storage 611. Persistent storage 611 may be a read only memory (ROM), but typically at least a portion of the persistent storage allows writing of data, deletion of data and re-writing of data. Some familiar forms of persistent storage include magnetic disks and solid state storage devices. Operating system 612 may take several forms, such as various known proprietary operating systems or open source Portable Operating System Interface type operating systems that employ a kernel. The code included in block 601 typically includes at least some of the computer code involved in performing the inventive methods.

Peripheral device set 613 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 614 may include components such as a display screen, speaker, microphone, wearable devices (such as goggles and smart watches), keyboard, mouse, printer, touchpad, game controllers, and haptic devices. Storage 615 is external storage, such as an external hard drive, or insertable storage, such as an SD card. Storage 615 may be persistent and/or volatile. In some embodiments, storage 615 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 616 is made up of sensors that can be used in Internet of Things applications. For example, one sensor may be a thermometer and another sensor may be a motion detector.

Network module 617 is the collection of computer software, hardware, and firmware that allows classical computer 102 to communicate with other computers through WAN 113. Network module 617 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 617 are performed on the same physical hardware device. In other embodiments (for example, embodiments that utilize software-defined networking (SDN)), the control functions and the forwarding functions of network module 617 are performed on physically separate devices, such that the control functions manage several different network hardware devices. Computer readable program instructions for performing the inventive methods can typically be downloaded to classical computer 102 from an external computer or external storage device through a network adapter card or network interface included in network module 617.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 602 is any computer system that is used and controlled by an end user (for example, a customer of an enterprise that operates classical computer 102), and may take any of the forms discussed above in connection with classical computer 102. EUD 602 typically receives helpful and useful data from the operations of classical computer 102. For example, in a hypothetical case where classical computer 102 is designed to provide a recommendation to an end user, this recommendation would typically be communicated from network module 617 of classical computer 102 through WAN 113 to EUD 602. In this way, EUD 602 can display, or otherwise present, the recommendation to an end user. In some embodiments, EUD 602 may be a client device, such as thin client, heavy client, mainframe computer, desktop computer and so on.

Remote server 603 is any computer system that serves at least some data and/or functionality to classical computer 102. Remote server 603 may be controlled and used by the same entity that operates classical computer 102. Remote server 603 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 618 of remote server 603.

Public cloud 604 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 604 is performed by the computer hardware and/or software of cloud orchestration module 620. The computing resources provided by public cloud 604 are typically implemented by virtual computing environments that run on various computers making up the computers of host physical machine set 621, which is the universe of physical computers in and/or available to public cloud 604. The virtual computing environments (VCEs) typically take the form of virtual machines from virtual machine set 622 and/or containers from container set 623. It is understood that these VCEs may be stored as images and may be transferred among and between the various physical machine hosts, either as images or after instantiation of the VCE. Cloud orchestration module 620 manages the transfer and storage of images, deploys new instantiations of VCEs and manages active instantiations of VCE deployments. Gateway 619 is the collection of computer software, hardware, and firmware that allows public cloud 604 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 605 is similar to public cloud 604, except that the computing resources are only available for use by a single enterprise. While private cloud 605 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 604 and private cloud 605 are both part of a larger hybrid cloud.

Block 601 further includes the software components discussed above in connection with FIGS. 2, 3A-3B, 4A-4C and 5A-5B to improve transpilation of dynamic quantum circuits. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for improving transpilation of dynamic quantum circuits, may be embodied in an application specific integrated circuit.

As stated above, transpilation of quantum circuits, including dynamic quantum circuits, is a fundamental step in quantum computation. Transpilation, which is performed by a component referred to as a transpiler, is the process of rewriting a given input quantum circuit to match the topology of a specific quantum device, and optimize the circuit instructions for execution on noisy quantum computers. It optimizes the quantum circuit by decomposing complex gates, rearranging qubits to match hardware connectivity, minimizing gate count, and managing available resources. The process ensures the quantum circuit retains functionality while maximizing performance and compatibility with the target hardware platform. Hence, it is a necessary step in order to execute the program on a quantum computer. However, it can alter the quantum circuit's characteristics, such as the width, the depth, and the gates. The stages of transpilation may include the following six stages. The first stage (init) is the initial stage, which runs initial passes that are required before the quantum circuit can be embedded. Such a stage typically involves unrolling custom instructions and converting the quantum circuit to all single and two-qubit gates. The second stage (layout) performs the mapping of the virtual qubits in the quantum circuit to the quantum processing unit's physical qubits. The third stage (routing) injects gates in the original quantum circuit to make it compatible with the quantum processing unit's connectivity. The fourth stage (translation) translates the gates in the quantum circuit to the quantum processing unit's basis set of instructions. In the fifth stage (optimization), an optimization loop is run to find more efficient decompositions of the quantum circuit until a condition is met (e.g., a particular depth of the quantum circuit, which represents the number of time steps required to complete all the gates in the quantum circuit). The sixth stage (scheduling) is used for any hardware-aware scheduling passes. For example, if the user specifies a scheduling method, the sixth stage accounts for all the idle time in the quantum circuit. The performance of dynamic quantum circuits depends on both the quantum processing unit of the quantum computer and the central processing unit of the classical computer upon which such quantum circuits are executed. For example, the performance of the dynamic quantum circuit depends on the limited coherence time and the qubit count involving the quantum processing unit. In another example, the performance of the dynamic quantum circuit depends on the information transmission rate, memory, and processing rate involving the central processing unit of the classical computer. However, the transpilation process of the dynamic quantum circuit does not take into consideration the classical portion involving the classical resources utilized by the dynamic quantum circuit upon which its performance depends. As a result, the current transpilation process of the dynamic quantum circuit may result in inadequate performance of the transpiled dynamic quantum circuit, including deficient quantum computational performance.

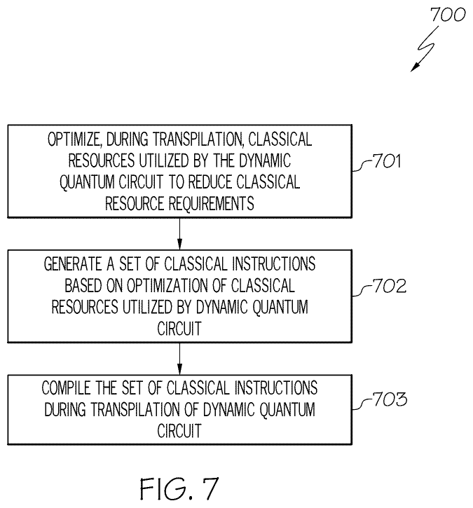

The embodiments of the present disclosure provide the means for optimizing, during transpilation of the dynamic quantum circuit, the classical resources utilized by the dynamic quantum circuit thereby improving the performance of the transpiled dynamic quantum circuit, including improving the quantum computational performance, as discussed below in connection with FIG. 7.

FIG. 7 is a flowchart of a method 700 for improving transpilation of dynamic quantum circuits in accordance with an embodiment of the present disclosure.

Referring to FIG. 7, in conjunction with FIGS. 1-2, 3A-3B 4A-4C, 5A-5B, and 6, in step 701, classical resource optimizer 201 of classical computer 102 optimizes, during transpilation of the dynamic quantum circuit, the classical resources utilized by the dynamic quantum circuit in order to reduce the classical resource requirements.

As stated above, classical resources, as used herein, refer to the resources utilized by the dynamic quantum circuit, upon which its performance depends, that relate to classical operations, such as operations performed by the central processing unit of classical computer 102.

In one embodiment, classical resource optimizer 201 optimizes the classical resources utilized by the dynamic quantum circuit using classical memory optimizer 202 to optimize (e.g., minimize) the classical memory requirements, classical processing optimizer 203 to optimize (e.g., minimize) the classical processing time, and classical information flow optimizer 204 to optimize the classical information flow.

In one embodiment, classical memory optimizer 202 is configured to manage classical memory to efficiently use on-chip classical resources.

In one embodiment, classical memory optimizer 202 optimizes the classical memory requirements by re-using a classical register for a repeat-until-success loop as shown in FIGS. 3A-3B.

As shown in FIG. 3A, a unitary operation (U) 301 is applied to qubits q20 and q21 followed by applying mid-circuit measurement 302A to qubit q20 performed by dynamic quantum circuit 300. After the mid-circuit measurement of unitary operation (U) 301 is applied to qubit q2 the result is stored in classical register 303A (cr0). Dynamic quantum circuit 300 applies U₀ 304A if the measurement reports 0, which is exported to the expression (expr) namespace on classical register 303A (cr0). Such an operation is repeated with respect to applying mid-circuit measurement 302B to qubit q21 involving classical register 303B (cr1).

For example, FIG. 3A illustrates applying mid-circuit measurement 302B to qubit q21 performed by dynamic quantum circuit 300. After the mid-circuit measurement of unitary operation (U) 301 is applied to qubit q21, the result is stored in classical register 303B (cr1). Dynamic quantum circuit 300 applies U₁ 304B if the measurement reports 0, which is exported to the expression (expr) namespace on classical register 303B (cr1).

Since dynamic quantum circuit 300 performs a repeat-until-success operation, a classical register may be re-used thereby minimizing classical memory requirements.

For example, as shown in FIG. 3B, the results of applying the mid-circuit measurements, mid-circuit measurements 302A, 302B, of unitary operation (U) 301 to qubits q30 and q31, respectively, are now stored in a single classical register 305 (cr). Dynamic quantum circuit 300 applies U₀ 304A if the measurement (applying mid-circuit measurement 302A to qubit q30) reports 0, which is exported to the expression (expr) namespace on classical register 305 (cr), and applies U₁ 304B if the measurement (applying mid-circuit measurement 302B to qubit q31) reports 0, which is exported to the expression (expr) namespace on classical register 305 (cr).

Another example of optimizing (e.g., minimizing) the classical memory requirements includes merging classical bits in response to identifying symmetries in classical logic conditions.

A further example of optimizing (e.g., minimizing) the classical memory requirements includes re-using the classical register based on the scheduling of parallel operations in the dynamic quantum circuit.

Another example of optimizing (e.g., minimizing) the classical memory requirements involves using the knowledge of the memory limit of classical controllers to reduce the number of classical registers required to execute the classical logic.

In one embodiment, classical memory optimizer 202 optimizes (e.g., minimizes) the classical memory requirements in the manner discussed above using various software tools, which may include, but are not limited to, Qiskit®, Cirq®, Quipper, Quantinuum®, etc.

In one embodiment, classical processing optimizer 203 is configured to optimize (e.g., minimize) the classical processing time.

In one embodiment, classical processing optimizer 203 optimizes (e.g., minimizes) the classical processing time by minimizing feed-forward times, and thus, decreasing decoherence. Feed-forward, as used herein, refers to using selective measurements during the execution of a quantum circuit (e.g., dynamic quantum circuit) and adapts future operations depending on those measurement results. Feed-forward time, as used herein, refers to the duration of time that a feed-forward operation occurs. Decoherence, as used herein, refers to the process by which information of a quantum system is altered by the system's interaction with its environment, hence creating an entanglement between the quantum system and the environment.

In one embodiment, feed-forward times are minimized by optimizing the classical logic as illustrated in FIGS. 4A-4C.

As shown in FIGS. 4A-4C, there may be several different classical expressions for performing the same function, such as performing unitary operations (unitaryA, unitaryB, unitaryC, and unitaryD) on qubits 0 and 1.

For example, FIG. 4A illustrates a classical expression using a series of if statements (four if statements) to represent classical logic for performing unitary operations (unitaryA, unitaryB, unitaryC, and unitaryD) on qubits 0 and 1.

In one embodiment, classical processing optimizer 203 performs an analysis for the classical expression, such as shown in FIG. 4A, as to the total feed-forward time for performing the classical expression. As illustrated in FIG. 4A, the total feed-forward time for performing the classical expression of FIG. 4A is 4*t_{FF}, where t_{FF} corresponds to the time for the feed-forward operation of a single classical expression.

FIG. 4B illustrates a classical expression using a series of if-else statements (two sets of if-else statements) to perform the same classical logic as shown in FIG. 4A, i.e., classical logic for performing unitary operations (unitaryA, unitaryB, unitaryC, and unitaryD) on qubits 0 and 1.

As previously discussed, classical processing optimizer 203 performs an analysis for the classical expression, such as shown in FIG. 4B, as to the total feed-forward time for performing the classical expression. As illustrated in FIG. 4B, the total feed-forward time for performing the classical expression of FIG. 4B is 2*t_{FF}, which is smaller than the feed-forward time for performing the classical expression of FIG. 4A.

FIG. 4C illustrates a classical expression using a switch statement to perform the same classical logic as shown in FIGS. 4A and 4B, i.e., classical logic for performing unitary operations (unitaryA, unitaryB, unitaryC, and unitaryD) on qubits 0 and 1.

As discussed above, classical processing optimizer 203 performs an analysis for the classical expression, such as shown in FIG. 4C, as to the total feed-forward time for performing the classical expression. As illustrated in FIG. 4C, the total feed-forward time for performing the classical expression of FIG. 4C is t_{FF}+dec(case)*t_{case} which is smaller than the feed-forward time for performing the classical expressions of FIGS. 4A and 4B, where t_{case} is the time to evaluate a single case in a switch statement, and where dec( ) converts a binary into decimal form (e.g., dec(00)=0, dec(01)=1, dec(10)=2, dec(11)=3).

After considering the different feed-forward times for each classical expression, the classical logic with the minimal feed-forward time is then selected to be utilized. In this manner, classical logic is optimized to minimize the feed-forward time, and thus, decrease decoherence.

In one embodiment, classical processing optimizer 203 performs an analysis for the classical expressions, such as shown in FIGS. 4A-4C, as to the total feed-forward time for performing the classical expression using various software tools, which may include, but are not limited to, Qiskit®, Cirq®, Quipper, Quantinuum®, etc.

Another example of classical processing optimizer 203 optimizing (e.g., minimizing) the classical processing time includes approximating compilation, where low-probability classical cases are discarded to minimize the compilation overhead.

A further example of classical processing optimizer 203 optimizing (e.g., minimizing) the classical processing time includes optimizing quantum gates across classical logic conditions. For example, if before the classical condition a unitary operation (U) is applied, and for the other cases, the unitary operation (U) and identity operation (I) are applied, then the quantum gate count can be minimized by not applying any gates before the classical condition and applying the unitary operation (U) for fewer conditions.

Another example of classical processing optimizer 203 optimizing (e.g., minimizing) the classical processing time includes replacing the classical logic with an efficient quantum circuit. For example, the parity measurement is projected out to an ancilla qubit. A parity measurement is a procedure in quantum information science used for error detection in quantum qubits. A parity measurement checks the equality of two qubits to return a true or false answer, which can be used to determine whether a correction needs to occur. Such a measurement may be stored in an ancilla qubit. Ancilla qubits, as used herein, refer to the extra qubits used to implement irreversible logical operations. For example, when translating a classical circuit into a quantum circuit, extra qubits are introduced because quantum computers only implement reversible logic. Such extra qubits are referred to as “ancilla”(or ancillary) qubits.

A further example of classical processing optimizer 203 optimizing (e.g., minimizing) the classical processing time includes iterating with the management of classical memory. For example, a single bit is stored in response to unitaries being determined by a symmetry of a wave function.

In one embodiment, classical processing optimizer 203 optimizes (e.g., minimizes) the classical processing time in the various manners discussed above using various software tools, which may include, but are not limited to, Qiskit®, Cirq®, Quipper, Quantinuum®, etc.

In one embodiment, classical information flow optimizer 204 is configured to optimize the classical information flow.

For example, classical information flow optimizer 204 optimizes the classical information flow by controlling the information flow to prevent the classical processors from crashing as shown in FIGS. 5A-5B.

As shown in FIG. 5A, a classical processors is requested to store five bits per time step 501 or group of qubits (q7₀, q7₁, q7₂, q7₃, and q7ᵣ). For example, measurement operations 502 are performed for various qubits (q7₀, q7₁, q7₂, q7₃, and q7ᵣ), where such measurement operations 502 output five bits of classical information to classical processor 503 (c4) per time step 501.

If such a classical processor can only store at most 3 bits per time step or group of qubits before failing, then the information flow needs to be adjusted in such a manner that the classical processor only stores 3 bits per time step as shown in FIG. 5B.

FIG. 5B illustrates that time step 501 of FIG. 5A is divided into two separate time steps, such as time steps 504 and 505. Such time steps, such as time steps 504 and 505, ensure that the classical processor does not store more than 3 bits per time step or group of qubits. For example, measurement operations 502 are performed for qubits q8₀, q8₁, and q8₂ over time step 504 and measurement operations 502 are performed for qubits q8₃, and q8₄ over time step 505. Measurement operations 502 for qubits q8₀, q8₁, and q8₂ output three bits of classical information to classical processor 506 (c5) over time step 504 and measurement operations 502 for qubits q8₃, and q8₄ output two bits of classical information over time step 505 to classical processor 506 (c5). In this manner, by controlling the information flow, the crashing of classical processors is prevented.

Another example of classical information flow optimizer 204 optimizing the classical information flow includes adjusting the classical information flow based on the limitations of each of the classical processors attached to the different qubits. For example, different qubits may be attached to different classical processors, each with their own information flow limitations, such as classical bit register sizes, flow rate, or complexity of logical processing. By taking into consideration such limitations, the classical information flow may be optimized, such as by adjusting the classical bit register sizes, flow rate, or complexity of logical processing.

A further example of classical information flow optimizer 204 optimizing the classical information flow includes iterating with the optimization of classical logic with cumulative cost functions. For instance, classical logic conditions that need be performed in sequence versus parallel are identified in order to optimize the classical logic with cumulative cost functions.

Another example of classical information flow optimizer 204 optimizing the classical information flow includes iterating with subsequent steps of the standard transpilation stages (e.g., translation, optimization, scheduling). For instance, the quantum gates that can be performed in parallel with classical logic are identified, which can be used to optimize the classical information flow.

In one embodiment, classical information flow optimizer 204 optimizes the classical information flow in the various manners discussed above using various software tools, which may include, but are not limited to, Qiskit®, Cirq®, Quipper, Quantinuum®, etc.

As a result of such optimization to the classical resources, the classical resource requirements are reduced.

In step 702, generator 205 of classical computer 102 generates a set of classical instructions based on the optimization of the classical resources utilized by the dynamic quantum circuit.

As discussed above, for example, generator 205 may generate a set of classical instructions to re-use a classical register as discussed above in connection with FIGS. 3A-3B. In another example, generator 205 may generate a set of classical instructions to utilize the classical logic shown in FIG. 4C, which minimizes the feed-forward time, and thus decreases decoherence. In a further example, generator 205 may generate a set of classical instructions to limit the classical processor from not storing greater than a maximum number of bits per time step or group of qubits in order to prevent crashing of the classical processor as discussed above in connection with FIGS. 5A-5B.

In one embodiment, generator 205 generates such a set of classical instructions using OpenQASM. In one embodiment, such classical instructions may include both low-level and high-level instructions. Such low-level instructions include classical bits and registers, comparison (Boolean) instructions, integers, angles, floating-point numbers, complex numbers, evaluation orders, looping and branching (e.g., if-else statements, for loops, while loops, etc.), switch statements, etc. Higher-level instructions include external function calls, which execute complex blocks of classical code.

In another embodiment, generator 205 generates such a set of classical instructions using the Instruction class of Qiskit®.

In step 703, compiler 206 of classical computer 102 compiles the set of classical instructions during the transpilation of the dynamic quantum circuit.

As stated above, in one embodiment, compiling classical instructions involves a process that translates classical code into a quantum algorithm that can be executed on quantum computer 101. For example, compiler 206 may break down the classical code into its basic building blocks and replace control and data structures with quantum primitives.

In one embodiment, the set of instructions are compiled between an optimization step and a scheduling step during the transpilation of the dynamic quantum circuit (e.g., quantum circuit 109).

In one embodiment, compiler 206 performs such compilation using the classical function compiler of Qiskit®. In one embodiment, the classical function compiler of Qiskit® maps the classical functions into a quantum circuit. In one embodiment, the classical function compiler of Qiskit® uses the Tweedledum library to represent the logic networks and to synthesize them into quantum circuits.

In this manner, by optimizing, during the transpilation of the dynamic quantum circuit, the classical resources utilized by the dynamic quantum circuit, there is an improved performance of the transpiled dynamic quantum circuit, including an improvement in the quantum computational performance.

Furthermore, the principles of the present disclosure improve the technology or technical field involving transpilation of dynamic quantum circuits.

As discussed above, transpilation of quantum circuits, including dynamic quantum circuits, is a fundamental step in quantum computation. Transpilation, which is performed by a component referred to as a transpiler, is the process of rewriting a given input quantum circuit to match the topology of a specific quantum device, and optimize the circuit instructions for execution on noisy quantum computers. It optimizes the quantum circuit by decomposing complex gates, rearranging qubits to match hardware connectivity, minimizing gate count, and managing available resources. The process ensures the quantum circuit retains functionality while maximizing performance and compatibility with the target hardware platform. Hence, it is a necessary step in order to execute the program on a quantum computer. However, it can alter the quantum circuit's characteristics, such as the width, the depth, and the gates. The stages of transpilation may include the following six stages. The first stage (init) is the initial stage, which runs initial passes that are required before the quantum circuit can be embedded. Such a stage typically involves unrolling custom instructions and converting the quantum circuit to all single and two-qubit gates. The second stage (layout) performs the mapping of the virtual qubits in the quantum circuit to the quantum processing unit's physical qubits. The third stage (routing) injects gates in the original quantum circuit to make it compatible with the quantum processing unit's connectivity. The fourth stage (translation) translates the gates in the quantum circuit to the quantum processing unit's basis set of instructions. In the fifth stage (optimization), an optimization loop is run to find more efficient decompositions of the quantum circuit until a condition is met (e.g., a particular depth of the quantum circuit, which represents the number of time steps required to complete all the gates in the quantum circuit). The sixth stage (scheduling) is used for any hardware-aware scheduling passes. For example, if the user specifies a scheduling method, the sixth stage accounts for all the idle time in the quantum circuit. The performance of dynamic quantum circuits depends on both the quantum processing unit of the quantum computer and the central processing unit of the classical computer upon which such quantum circuits are executed. For example, the performance of the dynamic quantum circuit depends on the limited coherence time and the qubit count involving the quantum processing unit. In another example, the performance of the dynamic quantum circuit depends on the information transmission rate, memory, and processing rate involving the central processing unit of the classical computer. However, the transpilation process of the dynamic quantum circuit does not take into consideration the classical portion involving the classical resources utilized by the dynamic quantum circuit upon which its performance depends. As a result, the current transpilation process of the dynamic quantum circuit may result in inadequate performance of the transpiled dynamic quantum circuit, including deficient quantum computational performance.

Embodiments of the present disclosure improve such technology by optimizing, during transpilation of the dynamic quantum circuit, the classical resources utilized by the dynamic quantum circuit to reduce classical resource requirements thereby improving performance of the transpiled dynamic quantum circuit. In one embodiment, such optimization of the classical resources utilized by the dynamic quantum circuit to reduce classical resource requirements is based on optimizing the classical memory requirements, optimizing the classical processing time, and/or optimizing the classical information flow. For example, optimizing the classical memory requirements may involve using the knowledge of the memory limit of classical controllers to reduce the number of classical registers required to execute the classical logic. In another example, optimizing the classical processing time may involve minimizing feed-forward times. In a further example, optimizing the classical information flow may involve limiting a classical processor to not store greater than a maximum number of bits per time step or group of qubits in order to prevent crashing by the classical processor. Upon optimizing, during transpilation, the classical resources utilized by the dynamic quantum circuit, a set of classical instructions is generated based on the optimization of the classical resources. Such classical instructions are then compiled during the transpilation of the dynamic quantum circuit. As previously discussed, the performance of the dynamic quantum circuit depends on the utilization of the classical resources. As a result of optimizing, during the transpilation of the dynamic quantum circuit, the classical resources utilized by the dynamic quantum circuit to reduce classical resource requirements, there is an improved performance of the transpiled dynamic quantum circuit, including an improvement in the quantum computational performance. Furthermore, in this manner, there is an improvement in the technical field involving transpilation of dynamic quantum circuits.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for improving transpilation of dynamic quantum circuits, the method comprising:
optimizing, during transpilation of a dynamic quantum circuit, classical resources utilized by said dynamic quantum circuit to reduce classical resource requirements;
generating a set of classical instructions based on said optimization of said classical resources utilized by said dynamic quantum circuit; and
compiling said set of classical instructions during said transpilation of said dynamic quantum circuit.

2. The method as recited in claim 1 further comprising:
optimizing said classical resources utilized by said dynamic quantum circuit by performing one or more of the following in the group consisting of: optimizing classical memory requirements, optimizing classical processing time, and optimizing classical information flow.

3. The method as recited in claim 2, wherein said classical memory requirements are optimized by performing one or more of the following in the group consisting of: re-using a classical register for a repeat-until-success loop, merging classical bits in response to identifying symmetries in classical logic conditions, minimizing classical bit requirements over segments of said dynamic quantum circuit, and re-using said classical register based on scheduling of parallel operations in said dynamic quantum circuit.

4. The method as recited in claim 2, wherein said classical processing time is optimized by minimizing feed-forward times.

5. The method as recited in claim 2, wherein said classical processing time is optimized by performing one or more of the following in the group consisting of: identifying a shortest feed-forward time for a classical expression out of a plurality of classical expressions, approximating compilation, optimizing quantum gates across classical logic conditions, projecting out a parity measurement to an ancilla qubit, and storing a single bit in response to unitaries being determined by a symmetry of a wave function.

6. The method as recited in claim 2, wherein said classical information flow is optimized by performing one or more of the following in the group consisting of: limiting a classical processor to not store greater than a maximum number of bits per time step in order to prevent crashing, identifying classical logic conditions to be performed in sequence versus parallel in order to optimize classical logic with cumulative cost functions, and identifying quantum gates that can be performed in parallel with classical logic.

7. The method as recited in claim 1, wherein said set of classical instructions is compiled between an optimization step and a scheduling step during said transpilation of said dynamic quantum circuit.

8. A computer program product for improving transpilation of dynamic quantum circuits, the computer program product comprising one or more computer readable storage mediums having program code embodied therewith, the program code comprising programming instructions for:
optimizing, during transpilation of a dynamic quantum circuit, classical resources utilized by said dynamic quantum circuit to reduce classical resource requirements;
generating a set of classical instructions based on said optimization of said classical resources utilized by said dynamic quantum circuit; and
compiling said set of classical instructions during said transpilation of said dynamic quantum circuit.

9. The computer program product as recited in claim 8, wherein the program code further comprises the programming instructions for:
optimizing said classical resources utilized by said dynamic quantum circuit by performing one or more of the following in the group consisting of: optimizing classical memory requirements, optimizing classical processing time, and optimizing classical information flow.

10. The computer program product as recited in claim 9, wherein said classical memory requirements are optimized by performing one or more of the following in the group consisting of: re-using a classical register for a repeat-until-success loop, merging classical bits in response to identifying symmetries in classical logic conditions, minimizing classical bit requirements over segments of said dynamic quantum circuit, and re-using said classical register based on scheduling of parallel operations in said dynamic quantum circuit.

11. The computer program product as recited in claim 9, wherein said classical processing time is optimized by minimizing feed-forward times.

12. The computer program product as recited in claim 9, wherein said classical processing time is optimized by performing one or more of the following in the group consisting of: identifying a shortest feed-forward time for a classical expression out of a plurality of classical expressions, approximating compilation, optimizing quantum gates across classical logic conditions, projecting out a parity measurement to an ancilla qubit, and storing a single bit in response to unitaries being determined by a symmetry of a wave function.

13. The computer program product as recited in claim 9, wherein said classical information flow is optimized by performing one or more of the following in the group consisting of: limiting a classical processor to not store greater than a maximum number of bits per time step in order to prevent crashing, identifying classical logic conditions to be performed in sequence versus parallel in order to optimize classical logic with cumulative cost functions, and identifying quantum gates that can be performed in parallel with classical logic.

14. The computer program product as recited in claim 8, wherein said set of classical instructions is compiled between an optimization step and a scheduling step during said transpilation of said dynamic quantum circuit.

15. A system, comprising:
a memory for storing a computer program for improving transpilation of dynamic quantum circuits; and
a processor connected to said memory, wherein said processor is configured to execute program instructions of the computer program comprising:
optimizing, during transpilation of a dynamic quantum circuit, classical resources utilized by said dynamic quantum circuit to reduce classical resource requirements;
generating a set of classical instructions based on said optimization of said classical resources utilized by said dynamic quantum circuit; and
compiling said set of classical instructions during said transpilation of said dynamic quantum circuit.

16. The system as recited in claim 15, wherein the program instructions of the computer program further comprise:
optimizing said classical resources utilized by said dynamic quantum circuit by performing one or more of the following in the group consisting of: optimizing classical memory requirements, optimizing classical processing time, and optimizing classical information flow.

17. The system as recited in claim 16, wherein said classical memory requirements are optimized by performing one or more of the following in the group consisting of: re-using a classical register for a repeat-until-success loop, merging classical bits in response to identifying symmetries in classical logic conditions, minimizing classical bit requirements over segments of said dynamic quantum circuit, and re-using said classical register based on scheduling of parallel operations in said dynamic quantum circuit.

18. The system as recited in claim 16, wherein said classical processing time is optimized by minimizing feed-forward times.

19. The system as recited in claim 16, wherein said classical processing time is optimized by performing one or more of the following in the group consisting of: identifying a shortest feed-forward time for a classical expression out of a plurality of classical expressions, approximating compilation, optimizing quantum gates across classical logic conditions, projecting out a parity measurement to an ancilla qubit, and storing a single bit in response to unitaries being determined by a symmetry of a wave function.

20. The system as recited in claim 16, wherein said classical information flow is optimized by performing one or more of the following in the group consisting of: limiting a classical processor to not store greater than a maximum number of bits per time step in order to prevent crashing, identifying classical logic conditions to be performed in sequence versus parallel in order to optimize classical logic with cumulative cost functions, and identifying quantum gates that can be performed in parallel with classical logic.
